(19) United States
(12) Patent Application Publication
(10) Pub. No.: US 2016/0062633 A1
(43) Pub. Date: Mar. 3, 2016

(54) METHOD OF PROVIDING USER INTERFACE AND RECORDING MEDIUM AND CHARACTER INPUT DEVICE COMPRISING THE SAME

(71) Applicant: Sentence Inc., Gyeonggi-do (KR)

(72) Inventor: Jee Yun AHN, Gyeonggi-do (KR)

(21) Appl. No.: 14/554,323

(22) Filed: Nov. 26, 2014

(30) Foreign Application Priority Data
Sep. 3, 2014 (KR) 10-2014-0117209

(51) Int. Cl. G06F 3/0488; G06F 3/01; G06F 3/0489; G06F 3/041

(52) U.S. Cl. CPC G06F 3/04883; G06F 3/041; G06F 3/017; G06F 3/0489

(57) ABSTRACT

Provided are a method of providing a user interface, and a recording medium and a character input device comprising the same. The method of providing a user interface of a device including a touch screen, wherein the touch screen comprises a first area including a first input window to allow a user to enter a text, and a second area to display the text entered through the first area, the method including determining whether a user input received through the first area is a swipe gesture, and changing the first input window to a second input window different from the first input window according to a predetermined swipe gesture if it is determined that the user input is a swipe gesture.

### CROSS-REFERENCE TO RELATED APPLICATION

This application claims priority from Korean Patent Application No. 10-2014-0117209 filed on Sep. 3, 2014 in the Korean Intellectual Property Office, and all the benefits accruing therefrom under 35 U.S.C. 119, the contents of which in their entirety are herein incorporated by reference.

### BACKGROUND

1. Technical Field

The present inventive concept relates to a method of providing a user interface, and a recording medium and a character input device comprising the same, and more particularly to a user interface enabling a user to enter characters through a touch screen more efficiently.

2. Description of the Related Art

As a device including a touch screen, there are a tablet PC, a laptop, a personal mobile communication services terminal, a personal digital assistant (PDA), a smart phone, an international mobile telecommunication-2000 (IMT-2000), and the like.

The touch screen generally includes a display window (LCD) and a touch panel provided thereon. Thus, a user executes an application by touching an icon displayed on the touch screen with the tip of a finger and with a stylus, or enters characters and the like by touching a keyboard displayed on a predetermined area.

When entering characters via the touch screen, a soft keyboard with small-sized keys is used because of a limited screen size. However, when a multi-language input, a special character input, a voice input, and the like are used in combination, it is necessary to change a mode by using a particular toggle key in order to select a desired keyboard key. In this case, the speed at which the user enters characters may be reduced. This phenomenon occurs more frequently in the case of a multilingual user.

(Patent Document 1) Korean Patent Publication No. 2010-0067192

### SUMMARY

The present inventive concept provides a method of providing a user interface capable of changing a type of an input window for entering a text, or changing a template of a text input field by using a swipe gesture.

The present inventive concept also provides a recording medium comprising a method of providing a user interface capable of changing a type of an input window for entering a text, or changing a template of a text input field by using a swipe gesture.

The present inventive concept also provides a character input device capable of changing a type of an input window for entering a text, or changing a template of a text input field by using a swipe gesture.

However, the aspects of the present inventive concept are not restricted to the one set forth herein. The above and other aspects of the present inventive concept will become more apparent to those skilled in the art to which the present inventive concept pertains by referencing the detailed description of the present inventive concept given below.

These and other objects of the present inventive concept will be described in or be apparent from the following description of the preferred embodiments

According to an aspect of the present inventive concept, there is provided a method of providing a user interface of a device including a touch screen, wherein the touch screen comprises a first area including a first input window to allow a user to enter a text, and a second area to display the text entered through the first area, the method including determining whether a user input received through the first area is a swipe gesture, and changing the first input window to a second input window different from the first input window according to a predetermined swipe gesture if it is determined that the user input is a swipe gesture.

According to another aspect of the present inventive concept, there is provided a method of providing a user interface of a device including a touch screen, wherein the touch screen comprises a first area including an input window to allow a user to enter a text, and a second area to display the text entered through the first area, the method including determining whether a user input received through the second area is a swipe gesture, and applying a first template set in advance to at least a portion of the entered text or a screen displayed on the second area if it is determined that the user input is a swipe gesture.

According to another aspect of the present inventive concept, there is provided A character input device including a touch screen including a first area to display a first input window for entering a text, and a second area different from the first area to display the text entered through the first input window, a key input determination unit to receive an input signal inputted to the first input window via the touch screen, and determine whether the input signal is a swipe gesture, and a keyboard processing unit to change the first input window to a second input window different from the first input window by using an animation effect if the input signal is a swipe gesture.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a block diagram schematically showing a character input device according to an embodiment of the present inventive concept;

FIG. 2 is a block diagram schematically showing a character input device according to another embodiment of the present inventive concept;

FIG. 3 is a flowchart illustrating a method of providing a user interface according to an embodiment of the present inventive concept;

FIGS. 4 to 6 are diagrams explaining a method of providing a user interface according to an embodiment of the present inventive concept;

FIG. 7 is a flowchart illustrating a method of providing a user interface according to another embodiment of the present inventive concept;

FIG. 8 is a diagram explaining a method of providing a user interface according to another embodiment of the present inventive concept;

FIGS. 9 to 11 are diagrams explaining an input window according to some embodiments of the present inventive concept;

FIG. 12 is a flowchart illustrating a method of providing a user interface according to still another embodiment of the present inventive concept;

FIG. 13 is a diagram explaining a template according to still another embodiment of the present inventive concept.

FIG. 14 is a flowchart illustrating a method of providing a user interface according to still another embodiment of the present inventive concept;

FIGS. 15 and 16 are diagrams explaining a method of providing a user interface according to still another embodiment of the present inventive concept; and

FIGS. 17 and 18 are diagrams explaining a template according to some embodiments of the present inventive concept.

### DETAILED DESCRIPTION OF THE EMBODIMENTS

Advantages and features of the present inventive concept and methods of accomplishing the same may be understood more readily by reference to the following detailed description of preferred embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the present inventive concept will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by those skilled in the art to which the present inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

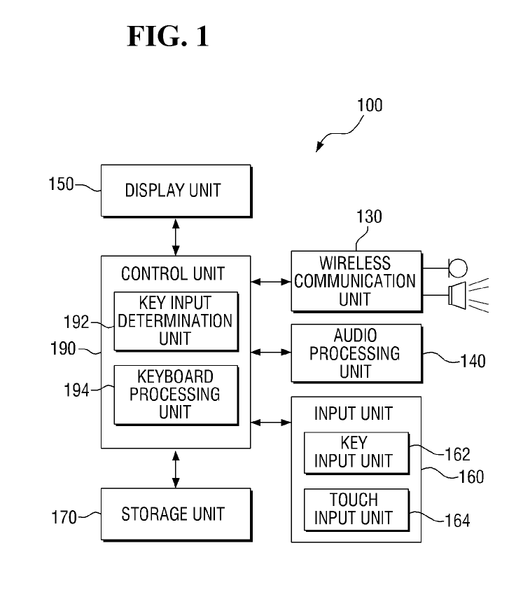

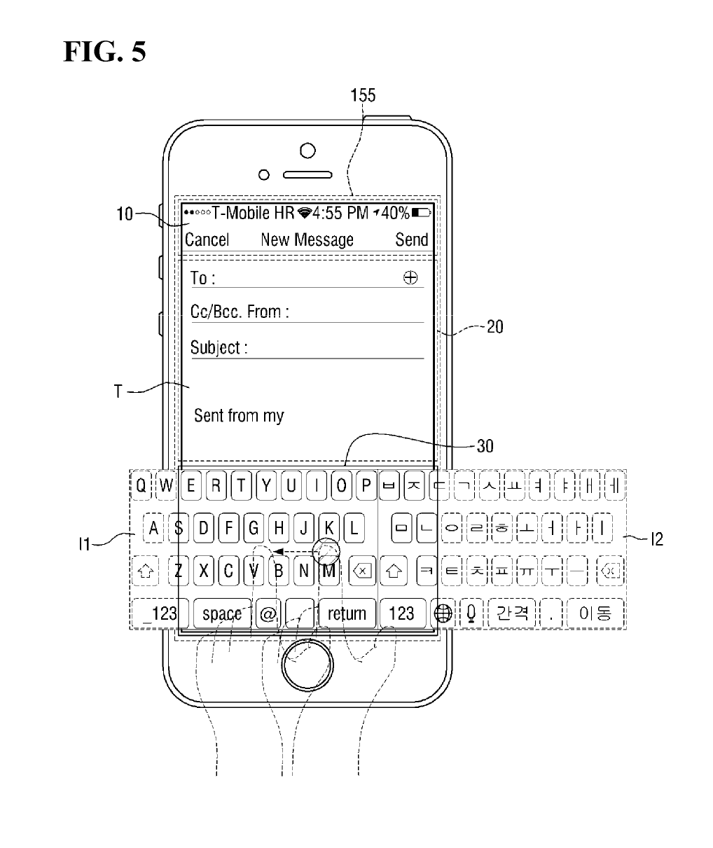

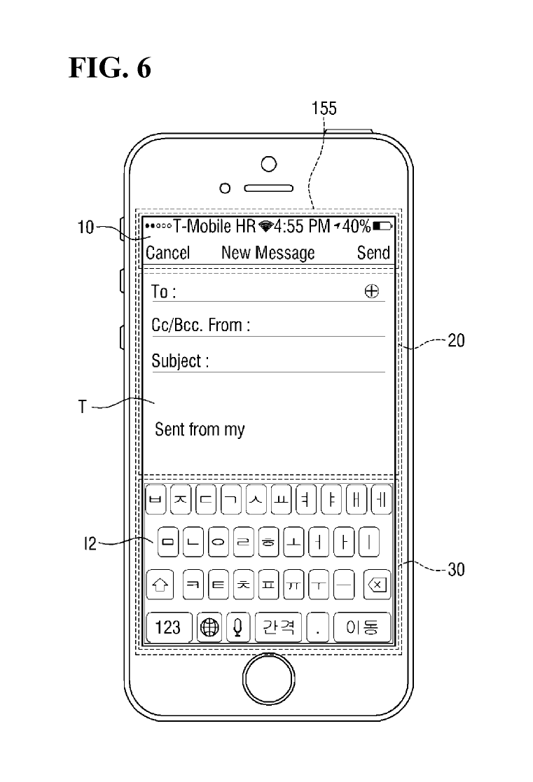

Hereinafter, a method of providing a user interface, and a recording medium and character input device comprising the same according to some embodiments of the present inventive concept will be described with reference to FIGS. 1 to 18.

FIG. 1 is a block diagram schematically showing a character input device according to an embodiment of the present inventive concept.

Referring to FIG. 1, a character input device 100 according to the present inventive concept includes a wireless communication unit 130, an audio processing unit 140, an input unit 160, a display unit 150, a storage unit 170, and a control unit 190.

The wireless communication unit 130 performs a data transmission and reception function for wireless communication of the character input device 100. The wireless communication unit 130 may include a RF transmitter for up-converting a frequency of a transmission signal and amplifying the up-converted transmission signal, and an RF receiver for low-noise-amplifying a received signal and down-converting a frequency of the low-noise-amplified signal. Further, the wireless communication unit 130 may receive data through a radio channel, output the data to the control unit 190, and transmit the data outputted from the control unit 190 via a radio channel. The wireless communication unit 130 may be omitted in the character input device 100. However, the present inventive concept is not limited thereto.

The audio processing unit 140 includes a codec (coder/decoder). The codec may include a data codec for processing packet data, and an audio codec for processing an audio signal such as voice. Accordingly, the audio processing unit 140 converts digital audio data received to the control unit 190 through the wireless communication unit 130 during a call into an analog audio signal via the audio codec and outputs the analog audio signal to a speaker. Further, the audio processing unit 140 converts an analog audio signal inputted from a microphone into digital audio data via the audio codec and provides the digital audio data to the control unit 190.

The display unit 150 visually provides a menu of the character input device 100, user data inputted by the user, function setting information, and other various information to the user. The display unit 150 is preferably formed of a liquid crystal display (LCD). In this case, the display unit 150 may include a controller for controlling the LCD, a video memory for storing image data, and elements of the LCD.

The input unit 160 receives an operation signal from the user to control the character input device 100 and transmits the operation signal to the control unit 190. To this end, the input unit 160, according to the present embodiment, includes a key input unit 162 to receive the operation signal through a key input (or touch input), and a touch input unit 164 attached on the above-described display unit 150, i.e., a liquid crystal panel. However, the present inventive concept is not limited to thereto, and the key input unit 162 may be omitted in the character input device 100.

The key input unit 162 includes a control key (not shown) for controlling the operation of the character input device 100 and a plurality of number keys (not shown) for inputting characters and numbers.

The touch input unit 164 generates an input signal from a voltage or current signal generated depending on the position where a touch occurs and transmits the input signal to the control unit 190.

The storage unit 170 stores downloaded contents and user data generated from the user as well as an application program required for a function operation according to the embodiment of the present inventive concept. The storage unit 170 may include a program area (not shown) and a data area (not shown).

The control unit 190 controls the overall operation of the character input device 100 and a signal flow between internal blocks of the character input device 100. That is, the control unit 190 controls a signal flow between the components of the character input device 100 including the wireless communication unit 130, the audio processing unit 140, the display unit 150, the input unit 160, and the storage unit 170.

The control unit 190 may execute each function of the character input device 100 according to the input signal inputted from the input unit 160 and display on the display unit 150 information such as a current status and a user menu according to the execution of the function.

A touch input method of the character input device 100 configured as described above will now be described.

When a touch event is generated from the user, the touch input unit 164, according to the embodiment of the present inventive concept, transmits coordinates where the touch event has occurred to the control unit 190. That is, the touch input unit 164 detects a voltage or current signal corresponding to a position (including both coordinates and traces thereof) where the touch event has occurred and transmits the coordinates to the control unit 190. Accordingly, the control unit 190 performs a function corresponding to the coordinates where the touch event has occurred. Further, the touch input unit 164 detects the time during which the position corresponding to the coordinates has been touched/pressed, and transmits the detected time to the control unit 190. Then, the control unit 190 performs a function set for an event corresponding to the detected time. Further, the control unit 190 may perform different functions depending on the time and the position pressed on the touch input unit 164. Meanwhile, as examples of the above-described touch event, there are a tap gesture, a swipe gesture, and the like. Further, the tap gesture may be classified into a long tap gesture of inputting a signal for a relatively long time and a short tap gesture of inputting a signal for a relatively short time.

Further, the control unit 190, according to the embodiment of the present inventive concept, may display an input window (e.g., a soft keyboard) through the display unit 150.

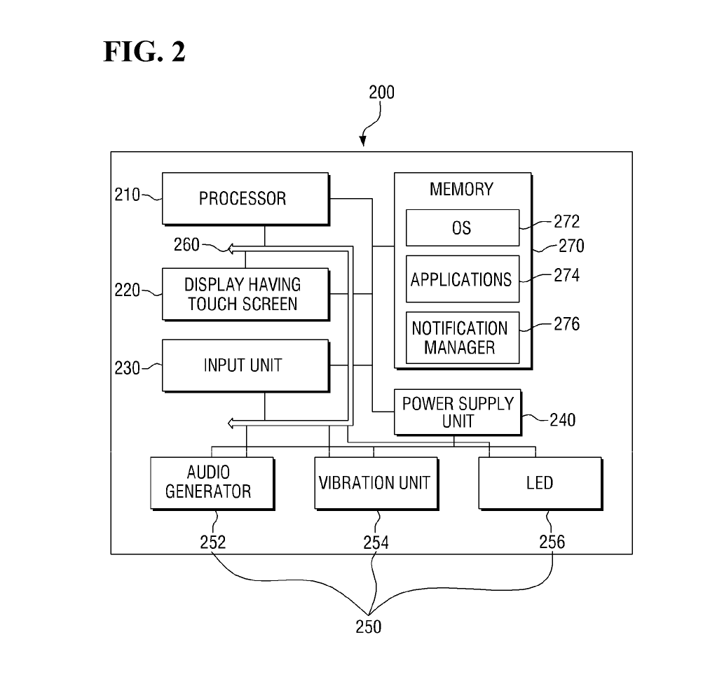

FIG. 2 is a block diagram schematically showing a character input device according to another embodiment of the present inventive concept.

Referring to FIG. 2, a character input device 200, according to another embodiment of the present inventive concept, includes a processor 210, a display 220, an input unit 230, a power supply unit 240, an external notification unit 250, a bus 260, and a memory 270. The character input device 200 may include a handheld computing device (e.g., a tablet PC and a laptop).

The processor 210 may be configured and operated in substantially the same way as the control unit 190 described with reference to FIG. 1. Similarly, the display 220 may be substantially the same as the display unit 150 described with reference to FIG. 1. That is, the display 220 may include a touch screen.

The input unit 230 may be an external input unit such as a keyboard, microphone, mouse, scanner, and camera. The input unit 230 may be connected wirelessly. However, the present inventive concept is not limited thereto.

The power supply unit 240 may be implemented as one or more batteries or some other power sources such as capacitors or fuel cells.

The external notification unit 250 may include three types of external notification units: an LED 256, a vibration unit 254, and an audio generator 252. However, the present inventive concept is not limited thereto.

The memory 270 may include a volatile memory (e.g., RAM) or a non-volatile memory (e.g., ROM and PCMCIA card). An operating system (OS) 272 may reside in the memory 270 and may be executed in the processor 210.

One or more application 274 may be loaded in the memory 270 and executed on the operating system 272. The applications may include an e-mail program, a scheduling program, a personal information management (PIM) program, a word processing program, a spreadsheet program, an Internet browser program, a game, and other well-known applications.

The character input device 200 may further include a notification manager 276 loaded in the memory 270. The notification manager 276 may process a notification request from the applications 274 and may be executed on the processor 210.

The processor 210, the display 220, the input unit 230, the power supply unit 240, the external notification unit 250, and the memory 270 may be coupled to each other via the bus 260. The bus 260 corresponds to a path through which data is transferred.

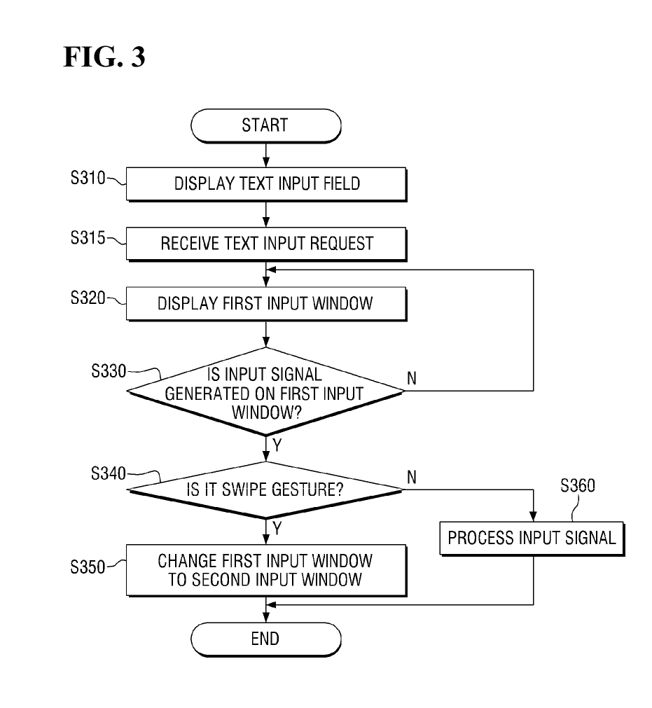

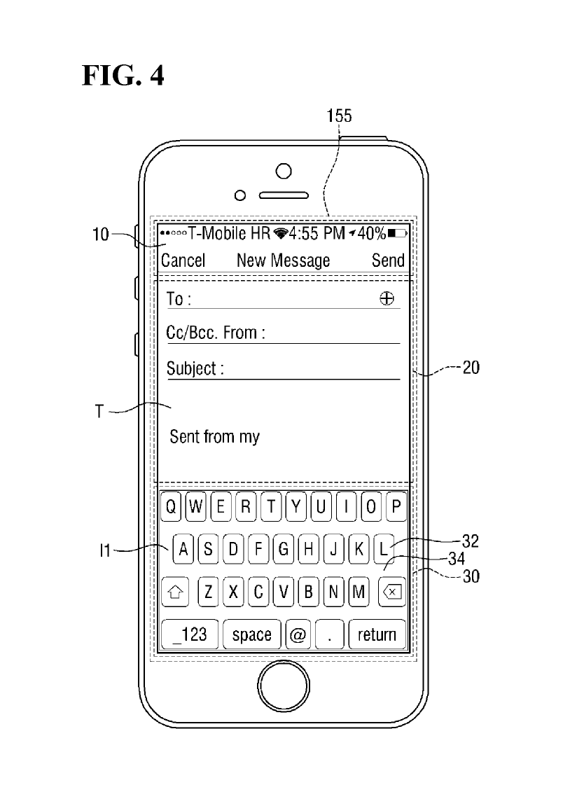

FIG. 3 is a flowchart illustrating a method of providing a user interface according to an embodiment of the present inventive concept. FIGS. 4 to 6 are diagrams explaining a method of providing a user interface according to an embodiment of the present inventive concept.

In the following description, the display unit 150 to which the touch input unit 164 is attached will be integrally referred to as a touch screen 155 (see FIG. 4) for convenience of explanation.

First, referring to FIG. 4, the touch screen 155 of the character input device may be divided into a first area 20, a second area 30, and a third area 10.

A text input field T may be disposed on the first area 20. Specifically, the first area 20 may include a recipient, cc., subject, and content input field. If the user touches the text input field T via the touch screen 155, a cursor may be located on the touched area, and a first input window I1 may appear on the second area 30. Before the first input window I1 appears, the text input field T may be disposed over the first area 20 and the second area 30. However, the present inventive concept is not limited thereto.

The first input window I1 may be disposed on the second area 30. For example, the first input window I1 may include a soft keyboard. Specifically, the first input window I1 appearing on the second area 30 may be any one of a first keyboard to receive an input of a first language, a second keyboard to receive an input of a second language different from the first language, a third keyboard to receive an input of special characters, a first screen to receive a voice input, a second screen to receive an OCR input, and a third screen to receive an input of an external device. In the following description, a case where the first input window Il is an English keyboard including a plurality of keys through which an English language is inputted will be described as an example.

The English keyboard, according to the present embodiment, may be configured to include a plurality of keys 32, and a blank area 34 between the keys 32. However, it is not limited thereto and may be formed of only the keys 32 without the blank area 34.

The keys 32 of the English keyboard, according to the present embodiment, may be arranged in the same way as the arrangement of a QWERTY keyboard, used widely and generally. Thus, the user can more easily use the keyboard through a familiar key arrangement. Further, the English keyboard, according to the present embodiment, may be represented as a two-dimensional plane, and most of the keys 32 may be formed in the same size. However, it may be displayed in various ways (e.g., in a three-dimensional manner) without being limited thereto.

Further, the control unit 190, according to the present embodiment, receives the characters according to an input signal inputted by the user via the touch screen 155. To this end, the control unit 190 may include a key input determination unit 192 and a keyboard processing unit 194.

The key input determination unit 192 may receive an input signal inputted through the touch screen 155, determine whether the input signal is a ‘character input signal’ or ‘input window switching signal,’ and deliver the determination result to the keyboard processing unit 194. The key input determination unit 192 determines that the input signal is a ‘character input signal’ if the input signal is inputted with a tap gesture and determines that the input signal is an ‘input window switching signal’ if the input signal is inputted with a swipe gesture.

Meanwhile, in the present embodiment, even though an input signal is inputted to the keys 32, if the input signal is a swipe gesture, it is determined that the input signal is an input window switching signal. However, the present inventive concept is not limited thereto, and various applications are possible. For example, in order to more accurately determine the input signal, only when the input signal is a swipe gesture starting from the blank area 34, it may be determined that the input signal is a movement signal of the soft keyboard.

The keyboard processing unit 194 displays the first input window I1 (e.g., English keyboard) on the touch screen 155 in response to a character input request. Further, the keyboard processing unit 194 may change the first input window I1 to another input window or input characters in response to the signal transmitted from the key input determination unit 192. For example, if the swipe gesture is inputted, the keyboard processing unit 194 receives the input window switching signal from the key input determination unit 192. Then, the keyboard processing unit 194 may change the first input window I1 displayed on the second area 30 to a second input window I2 different from the first input window I1.

Referring to FIGS. 3 and 4, in the method of providing a user interface according to the embodiment of the present inventive concept, first, the text input field T is displayed on the touch screen 155 (step S310). Specifically, the text input field T may be displayed on the first area 20 or the first and second areas 20 and 30.

Then, a text input request is received from the user (step S320). A text input request signal may be generated when the user touches the text input field T displayed on the touch screen 155 with the tip of a finger, a stylus, or the like.

Subsequently, if the text input request signal is generated, the first input window I1 may be displayed on the second area 30 (step S320). For example, the first input window I1 may be an English keyboard including a plurality of keys through which English language is inputted. However, the present inventive concept is not limited thereto.

Subsequently, it is determined whether an input signal is generated on the first input window I1. If the input signal is not generated on the first input window I1, step S320 is repeated.

Subsequently, if the input signal is generated on the first input window I1, the key input determination unit 192 determines whether the input signal is a swipe gesture (step S340). Specifically, the key input determination unit 192 determines whether the input signal is a tap gesture or swipe gesture. The key input determination unit 192 determines the input signal inputted with a tap gesture (e.g., short tap gesture) as a character input signal. Further, the key input determination unit 192 determines the input signal inputted with a swipe gesture as an input window switching signal. The character input signal or the input window switching signal is transmitted to the keyboard processing unit 194.

Subsequently, if the input signal is a swipe gesture, the keyboard processing unit 194 changes the first input window I1 to the second input window I2 (step S350). For example, the second input window I2 may be a Korean keyboard including a plurality of keys through which a Korean language is inputted. Accordingly, the English keyboard may be converted into the Korean keyboard. However, the present inventive concept is not limited thereto, and the first input window I1 or the second input window I2 may correspond to any one of a soft keyboard to receive an input of a language text or special characters, a first screen to receive a voice input, a second screen to receive an OCR input, and a third screen to receive an input of an external device.

On the other hand, if the input signal is a character input signal, the keyboard processing unit 194 inputs the character selected by the input signal into the text input field T (step S360).

Referring again to FIGS. 4 to 6, in the case where the first input window I1 is changed to the second input window I2, the second input window I2 may move in the direction of the swipe gesture to replace the first input window I1. For example, the first input window I1 may be changed to the second input window I2 by using an animation effect in the form connected to the second input window I2. In this case, the first input window I1 may be an English keyboard, the second input window I2 may be a Korean keyboard, and the English keyboard may be changed to the Korean keyboard by using the animation effect in the form connected to the Korean keyboard. Then, the changed keyboard (i.e., Korean keyboard) may also be displayed on the second area 30.

However, the present inventive concept is not limited thereto, and if a first swipe gesture in a first direction is inputted, the first input window I1 may be changed to the second input window I2 through an animation effect moving in the first direction. In this case, the second input window I2 may appear by using a separate animation effect. For example, as the animation effect, Fly in from a second direction different from the first direction, Blink, Dissolve, Appear and Change size, or the like may be used.

The third area 10 may be located at the top of the display unit 150 to include a state of the character input device, a state or information of the currently executed application, or other execution buttons. For example, current time, battery information, signal intensity, information of the executed application, and the like may be displayed on the third area 10. Hereinafter, a case of executing an e-mail program as an application program will be described as an example, but the present inventive concept is not limited thereto.

A send button or cancel button may be disposed on the third area 10, but the present inventive concept is not limited thereto.

In the method of providing a user interface and the character input device as described above, it is possible to intuitively change the type of the input window for inputting a text by using a swipe gesture in a particular direction. Thus, it is possible to efficiently change a plurality of input windows and to improve a character input speed of the user.

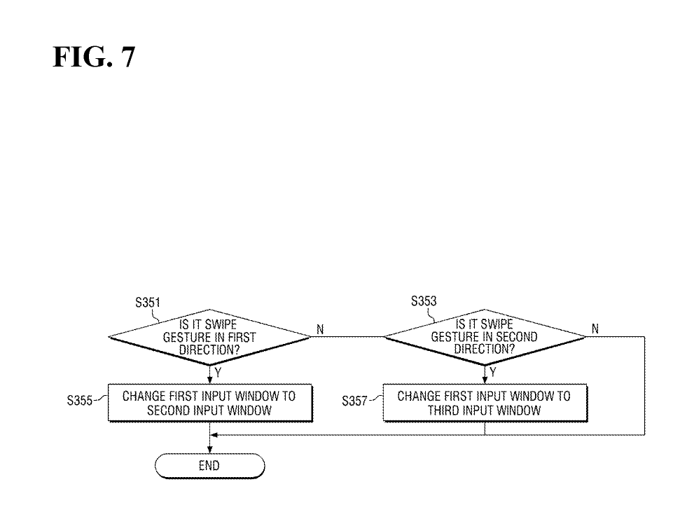

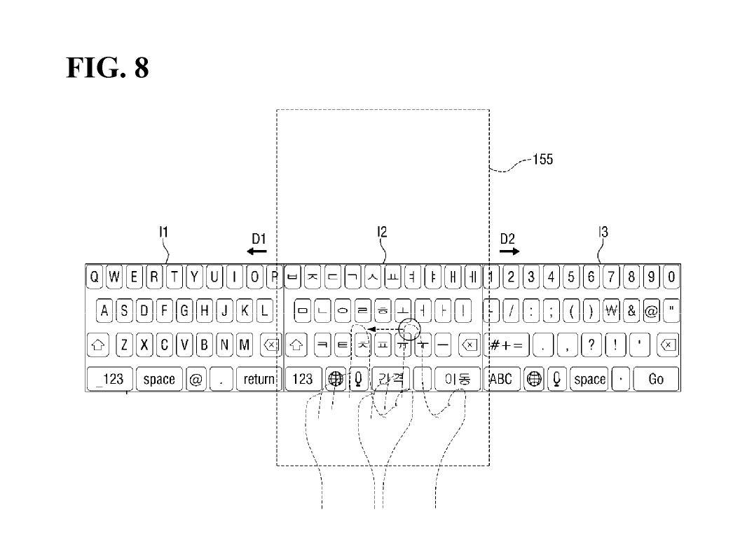

FIG. 7 is a flowchart illustrating a method of providing a user interface according to another embodiment of the present inventive concept. FIG. 8 is a diagram explaining a method of providing a user interface according to another embodiment of the present inventive concept. For the simplicity of description, a repeated description of the same configuration as the above-described embodiment will be omitted, and differences will be mainly described below.

Referring to FIGS. 7 and 8, a method of providing a user interface according to another embodiment of the present inventive concept is substantially similar to the method of providing a user interface described with reference to FIG. 3.

In step S350 of FIG. 3, it is determined whether the direction of the swipe gesture of the user is a first direction D1 (step S351). Subsequently, if the swipe gesture in the first direction D1 is inputted, a first input window I2 is changed to a second input window I1 (step S355). For example, the first input window I2 may be changed to the second input window I1 through an animation effect moving in the first direction D1.

On the other hand, if the swipe gesture of the user is not in the first direction D1, it is determined whether the swipe gesture of the user is in a second direction D2 (step S353). Subsequently, if the swipe gesture in the second direction D2 is inputted, the first input window I2 is changed to a third input window I3 (step S357). For example, the first input window I2 may be changed to the third input window I3 by using an animation effect moving in the second direction D2. In this case, the first input window I2 may include a plurality of keys to receive a Korean language, the second input window I1 may include a plurality of keys to receive an English language, and the third input window I3 may include a plurality of keys to receive special characters.

However, the present inventive concept is not limited thereto, and each of the first to third input windows I1 to I3 may correspond to any one of a first keyboard to receive an input of a first language, a second keyboard to receive an input of a second language different from the first language, a third keyboard to receive an input of special characters, a first screen to receive a voice input, a second screen to receive an OCR input, and a third screen to receive an input of an external input device. Each of the first to third input windows I1 to I3 may be changed by settings inputted in advance by the user. Further, the first direction D1 and the second direction D2 may be opposite to each other.

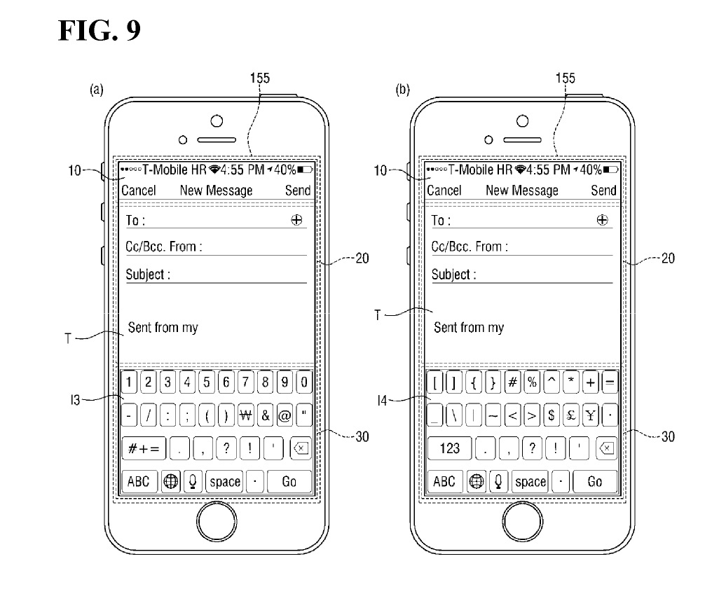

FIGS. 9 to 11 are diagrams explaining an input window according to some embodiments of the present inventive concept.

Referring to FIG. 9, (a) of FIG. 9 shows a keyboard I3 to receive an input of first special characters, and (b) of FIG. 9 shows a keyboard I4 to receive an input of second special characters. The arrangement of special characters shown in FIG. 9 is merely exemplary, and it is not limited to the arrangement shown in the drawings.

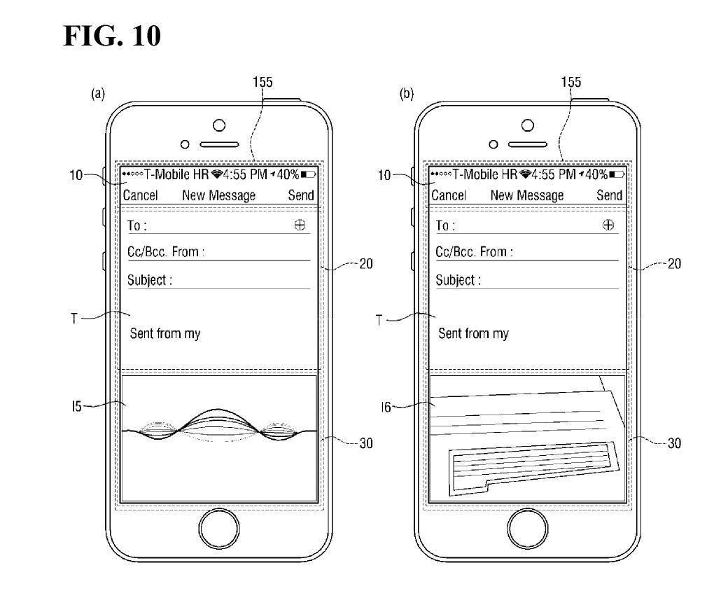

Referring to FIG. 10, (a) of FIG. 10 shows a screen 15 to receive a voice input, and (b) of FIG. 10 shows a screen I6 to receive an OCR input.

If the screen I5 for receiving a voice input is displayed on the second area 30, an audio processing unit (e.g. audio processing unit 140 of FIG. 1) may be activated. Then, after receiving voice from the outside through a microphone, the voice may be analyzed and converted into a text, and the text may be displayed on the text input field T. However, the present inventive concept is not limited thereto.

If the screen I6 for receiving an OCR input is displayed on the second area 30, although not shown specifically in the drawings, a camera (e.g., input unit 230 of FIG. 2) may be activated. Then, after receiving an image from the outside through the camera (e.g., input unit 230 of FIG. 2), a process of recognizing characters located on the captured screen by analyzing the image may be performed and the recognized text may be displayed on the text input field T. However, the present inventive concept is not limited thereto.

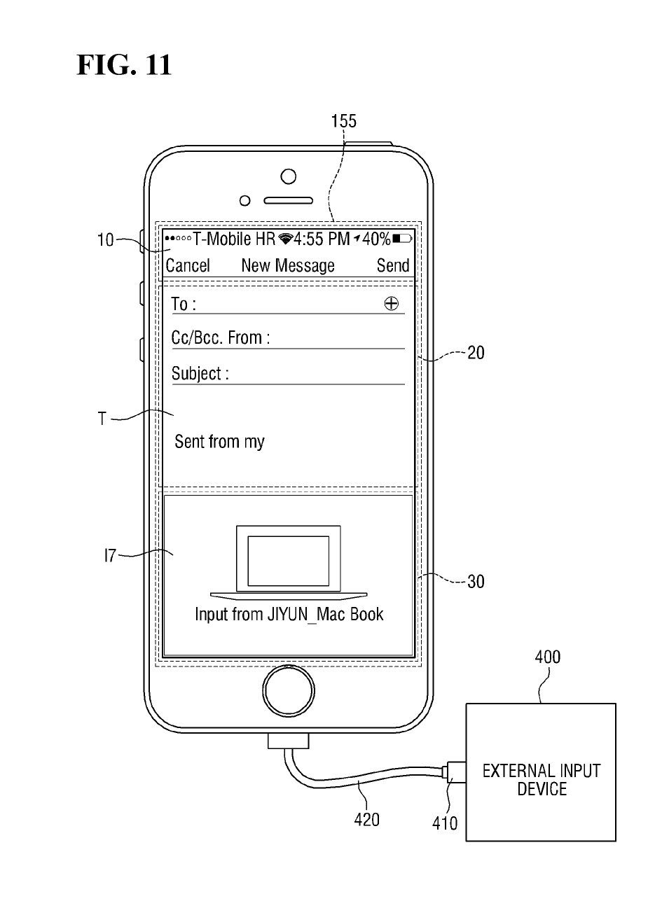

Referring to FIG. 11, FIG. 11 shows a screen 17 to receive an input of an external input device.

If the screen I7 for receiving an input of an external input device is displayed on the second area 30, a connection port (not shown) to the external input device connected to the character input device, according to some embodiments of the present inventive concept, may be activated. An external input device 400 may include a connection port 410. The external input device 400 may exchange data with the character input device through a connection cable 420 connected to the connection port 410.

However, the present inventive concept is not limited thereto, and the external input device and the character input device may exchange data by using wireless communication (e.g., WIFI, RF communication, and infrared communication). In the case where the screen I7 for receiving an input of an external input device is displayed on the second area 30, data inputted from the external input device may be received and displayed on the text input field T. However, the present inventive concept is not limited thereto.

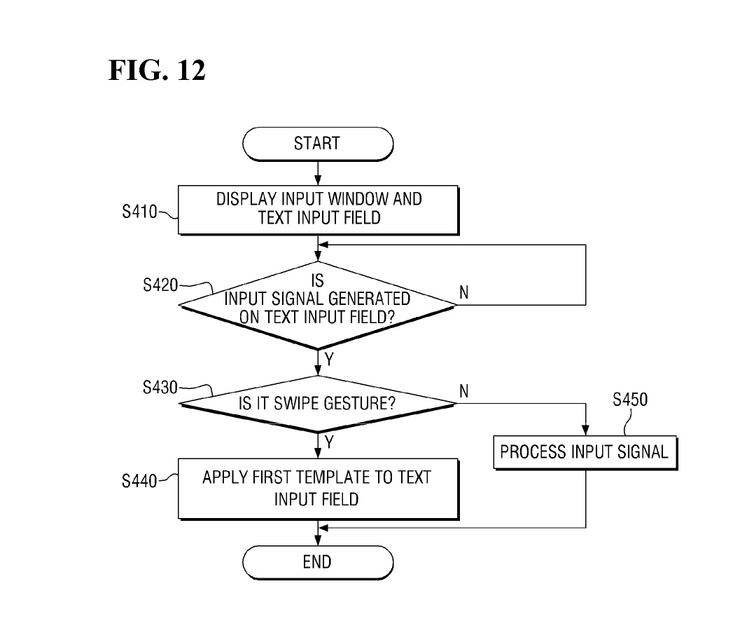

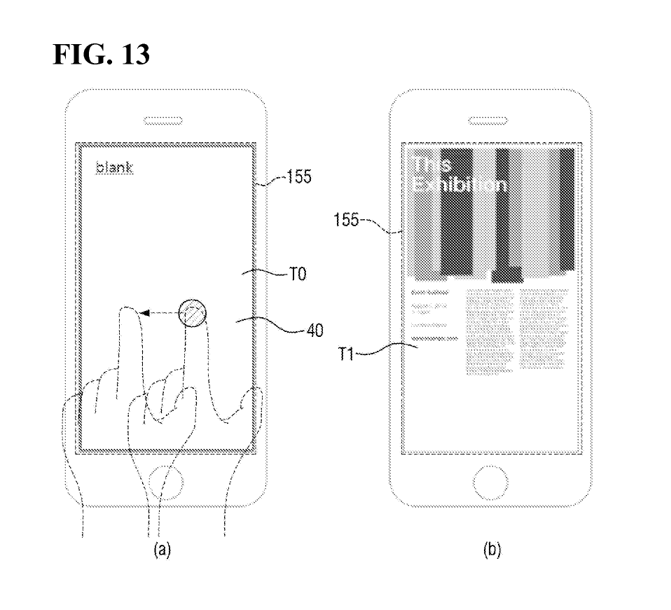

FIG. 12 is a flowchart illustrating a method of providing a user interface, according to still another embodiment of the present inventive concept. FIG. 13 is a diagram explaining a template, according to still another embodiment of the present inventive concept.

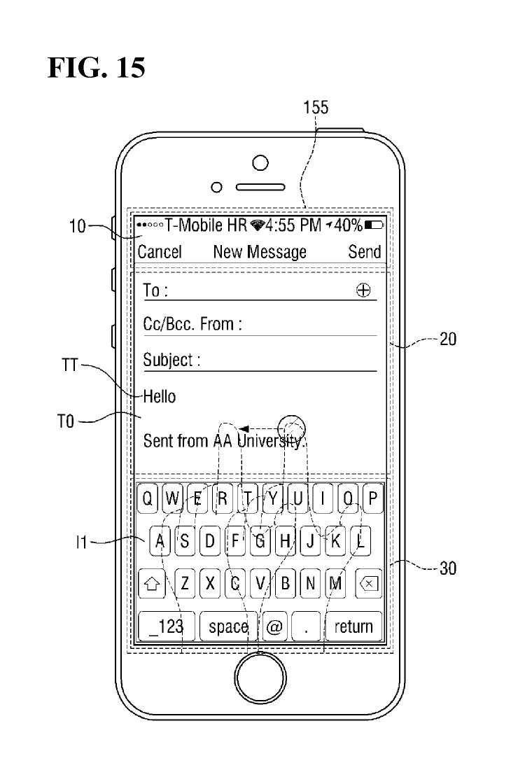

Referring to FIGS. 12 and 13, in the method of providing a user interface, according to still another embodiment of the present inventive concept, first, an input window I1 for inputting a text on a touch screen 155, and a text input field T0 for displaying the text inputted through the input window I1 are displayed (step S410). Specifically, the text input field T0 may be displayed partially or entirely on the touch screen 155. For example, the text input field T0 may be displayed on the entire area of the touch screen 155 (see (a) of FIG. 13). Further, the text input field T0 may be displayed only on the first area 20 (see FIG. 15). The input window I1 may be displayed on the second area 30. For example, the text input field T0 may include an address field to receive an input of a sending address of the e-mail, and a content description field to receive an input of contents of the e-mail. However, the present inventive concept is not limited thereto.

Subsequently, it is determined whether an input signal is generated on the text input field T0 (step S420). If the input signal is not generated on the text input field T0, step S420 is repeated.

Subsequently, if the input signal is generated on the text input field T0, the key input determination unit 192 determines whether the input signal is a swipe gesture (step S430). The operation of the key input determination unit 192 may be the same as that described with reference to FIG. 3.

Subsequently, if the input signal is a swipe gesture, the keyboard processing unit 194 changes the text input field T0 to a first template T1 (step S440). The first template T1 may include a font, a font size, and an image set in advance. For example, the first template Ti may be a template including an image and a font format of a newsletter. However, the present inventive concept is not limited thereto.

On the other hand, if the input signal is a character input signal, the keyboard processing unit 194 displays the input window I1 if the input window I1 is omitted, or moves a cursor to a position where the input signal is inputted (step S450).

Although not shown specifically in the drawings, if the text input field T0 is changed to the first template T1, the first template T1 may move in the direction of the swipe gesture and may be applied to the first area 20. For example, the text input field T0 may be changed to the first template T1 by using an animation effect in the form connected to the first template T1. However, the present inventive concept is not limited thereto.

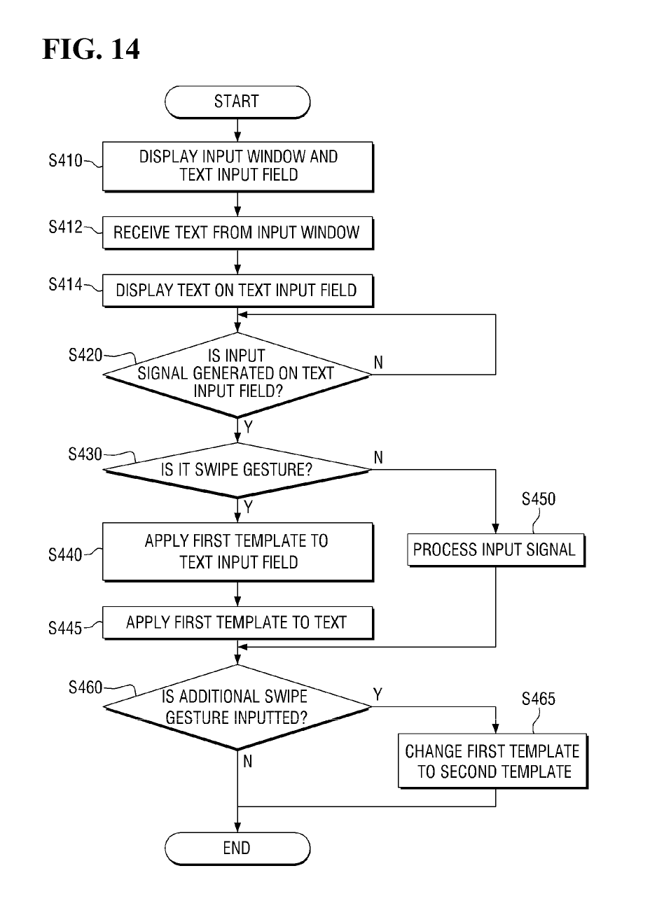

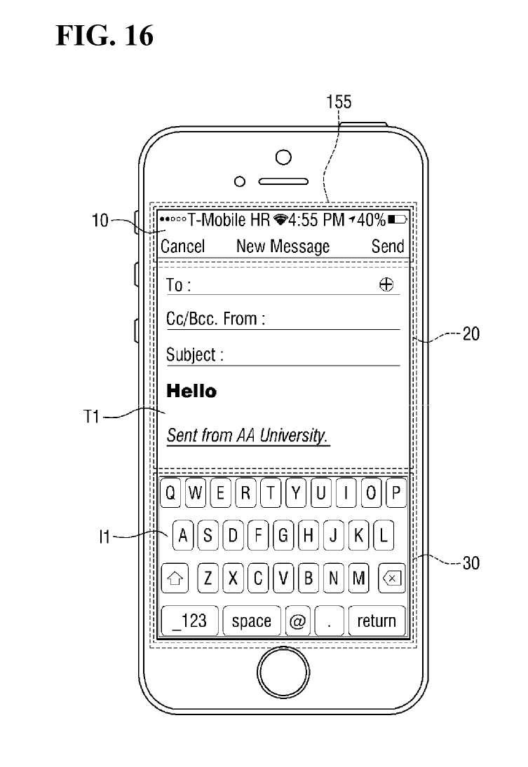

FIG. 14 is a flowchart illustrating a method of providing a user interface, according to still another embodiment of the present inventive concept. FIGS. 15 and 16 are diagrams explaining a method of providing a user interface, according to still another embodiment of the present inventive concept. For the simplicity of description, a repeated description of the same configuration as the above-described embodiment will be omitted, and differences will be mainly described below.

Referring to FIGS. 14 to 16, subsequently to step S410 of FIG. 12, a text TT is inputted by using the input window I1 (step S412). For example, the input window I1 may include a soft keyboard including a plurality of keys, but the present inventive concept is not limited thereto. Then, the text TT inputted in the text input field T0 is displayed (step S414).

Subsequently, it is determined whether the input signal is generated on the text input field T0 (step S420). If the input signal is not generated on the text input field T0, step S420 is repeated.

Then, if the input signal is generated on the text input field T0, the key input determination unit 192 determines whether the input signal is a swipe gesture (step S430).

Then, if the input signal is a swipe gesture, the first template T1 is applied to the text input field T0 (step S440).

Subsequently, a font or font size preset in the first template T1, or a template preset in the first template T1 is applied to the input text TT (step S445). For example, FIG. 15 shows a state where the text of ‘Hello’ and ‘sent from AA University’ has been inputted as a default format. Then, if a swipe gesture is inputted into the text input field T0, a template such as a font and font size preset in the first template T1 may be applied to the text. The text of ‘Hello’ may be bolded, sized up, and changed in font. The text of ‘sent from AA University’ may be italicized, underlined or sized down. However, the present inventive concept is not limited thereto.

The template of the first template T1 may be set in advance by the user. However, the present inventive concept is not limited thereto, and a template provided in advance by the program may be used as it is.

Although it has been illustrated in FIG. 14 that step S440 of changing the text input field T0 to the first template T1 and step S445 of applying the template to the input text are sequentially performed, the present inventive concept is not limited thereto. The sequence of performing step S440 and step S445 may be changed, or step S440 and step S445 may be performed at the same time.

On the other hand, if the input signal is a character input signal, the keyboard processing unit 194 displays the input window I1 if the input window I1 is omitted, or moves a cursor to a position where the input signal is inputted (step S450).

Then, it is determined whether an additional swipe gesture is inputted to the first template T1 (step S460).

Subsequently, if an additional swipe gesture is inputted to the first template T1, the first template T1 is changed to a second template (not shown) (step S465). The first template T1 and the second template (not shown) may be changed in sequence, type, or the like by the settings inputted in advance by the user. However, the present inventive concept is not limited thereto.

In the above-described method of providing a user interface, the template can be easily changed by using a swipe gesture in a particular direction. Thus, it is possible to improve convenience when writing a text.

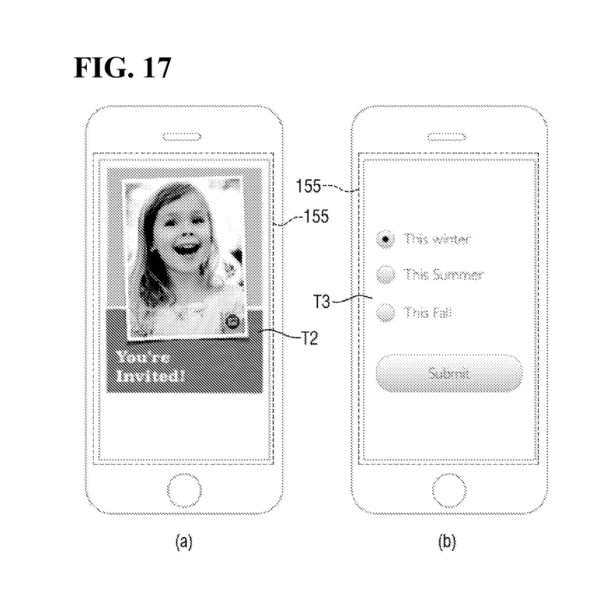

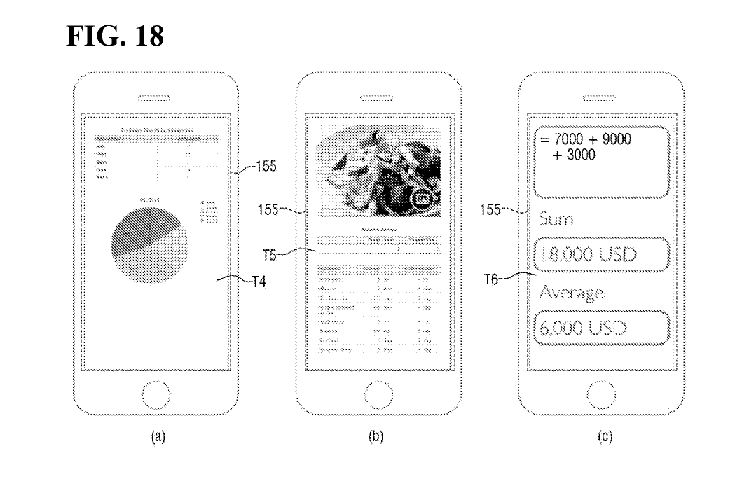

FIGS. 17 and 18 are diagrams explaining a template, according to some embodiments of the present inventive concept.

Referring to FIG. 17, (a) of FIG. 17 represents a template T2 including an image and a text format of an invitation, and may include an image or text format and the like. Further, (b) of FIG. 17 represents a survey template T3 and may include a plurality of options, and an algorithm for transmitting the user's response to a particular device.

Referring to FIG. 18, (a) of FIG. 18 represents an infographic template T4 including a graph and formulas, and may include a table and a graph to which the text can be inputted. Further, (b) of FIG. 18 represents a template T5 to which cooking recipe information can be inputted, and may include a table to which the text can be inputted, a frame to which a picture can be inputted, and the like. In addition, (c) of FIG. 18 represents a template T6 including a calculator function, and may include an algorithm that can perform the four fundamental arithmetic operations and a function calculation. However, the templates shown in FIGS. 17 and 18 are merely exemplary, and the present inventive concept is not limited thereto.

The above-described templates T1 to T6 may be stored in advance in the character input device and provided to the user. The user may preselect the template which is used frequently, and the sequence of templates that appear with a swipe gesture may be set in advance. However, the present inventive concept is not limited thereto.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor.

The processor and the storage medium can also reside in an application specific integrated circuit (ASIC). The ASIC can reside in a user terminal Alternatively, the processor or the storage medium can reside in a user terminal as an individual component.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

1. A method of providing a user interface of a device including a touch screen, wherein the touch screen comprises a first area including a first input window to allow a user to enter a text, and a second area to display the text entered through the first area,
the method comprising:
determining whether a user input received through the first area is a swipe gesture, and
changing the first input window to a second input window different from the first input window according to a predetermined swipe gesture if it is determined that the user input is a swipe gesture.

2. The method of claim 1, wherein, in said changing the first input window, if the swipe gesture is inputted, the second input window moves in a direction of the swipe gesture to replace the first input window.

3. The method of claim 1, wherein the second input window corresponds to any one of a soft keyboard to receive an input of a language text or special characters, a first screen to receive a voice input, a second screen to receive an OCR input, and a third screen to receive an input of an external input device.

4. The method of claim 3, wherein the second input window can be changed by settings inputted in advance by the user.

5. The method of claim 1, wherein the first input window comprises a first soft keyboard to receive an input of a text in a first language,
wherein if the swipe gesture is in a first direction, the second input window comprises a second soft keyboard to receive an input of a text in a second language different from the first language, and
wherein if the swipe gesture is in a second direction different from the first direction, the second input window comprises a third soft keyboard to receive an input of special characters.

6. The method of claim 1, further comprising applying a preset template to at least a portion of the text entered by the user or a screen displayed on the second area if it is determined that the user input is a swipe gesture.

7. The method of claim 6, wherein said applying a preset template comprises changing a font and a font size of the entered text according to preset values.

8. A recording medium storing a program to perform the method described in claim 1.

9. A method of providing a user interface of a device including a touch screen, wherein the touch screen comprises a first area including an input window to allow a user to enter a text, and a second area to display the text entered through the first area,
the method comprising:
determining whether a user input received through the second area is a swipe gesture; and
applying a first template set in advance to at least a portion of the entered text or a screen displayed on the second area if it is determined that the user input is a swipe gesture.

10. The method of claim 9, wherein in said applying a first template, the first template moves in a direction of the swipe gesture to be applied to the second area.

11. The method of claim 9, wherein said applying a first template comprises changing a font and a font size of the entered text according to preset values.

12. The method of claim 9, further comprising, if an additional swipe gesture is inputted after applying the first template, changing the first template to a second template different from the first template.

13. The method of claim 12, wherein the first and second templates can be changed by settings inputted in advance by the user.

14. A recording medium storing a program to perform the method described in claim 9.

15. A character input device comprising:
a touch screen including a first area to display a first input window for entering a text, and a second area different from the first area to display the text entered through the first input window;
a key input determination unit to receive an input signal inputted to the first input window via the touch screen, and determine whether the input signal is a swipe gesture; and
a keyboard processing unit to change the first input window to a second input window different from the first input window by using an animation effect if the input signal is a swipe gesture.

16. The character input device of claim 15, wherein the first input window comprises a first soft keyboard including a plurality of keys in a first language, and
wherein the second input window comprises a second soft keyboard including a plurality of keys in a second language different from the first language.
